(19) United States
(12) Patent Application Publication
(10) Pub. No.: US 2025/0264873 A1
(43) Pub. Date: Aug. 21, 2025

(54) SYSTEM AND METHOD FOR BUILDING SYSTEM FAULT DETECTION AND POWER MANAGEMENT

(71) Applicant: Energy Control Services LLC dba ECS Arizona, Phoenix, AZ (US)

(72) Inventor: Karl H. JUSTIN, Phoenix, AZ (US)

(73) Assignee: Energy Control Services LLC dba ECS Arizona, Phoenix, AZ (US)

(21) Appl. No.: 18/443,291

(22) Filed: Feb. 15, 2024

(51) Int. Cl. G05B 23/02; F24F 11/38

(52) U.S. Cl. CPC G05B 23/0283; F24F 11/38; G05B 23/0264

(57) ABSTRACT

A system and method for improving building system operation efficiency, thus lowering electric power consumption. The system accesses and utilizes data from various building system component monitoring sensors, building system controllers, and uses artificial intelligence (AI) based on machine learning models, which is trained using feedback for learning, to detect defective building system components. The system can generate a report that is sent to the building owner or building maintenance team. The report can include cost estimates for providing the services to help minimize the building maintenance teams effort and/or automate the process for maintenance as third-party repairs are scheduled automatically upon approval of the report's service estimates.

### TECHNICAL FIELD

The invention is in the field of computer systems and, more specifically, related to systems that use artificial intelligence for monitoring building system components to determine inefficiencies and failure.

### BACKGROUND

Building system management has historically relied upon building occupants and maintenance staff to detect lighting and equipment maintenance issues. Occupants of buildings such as hospitals, schools, office buildings, factories and other facilities report when a light burns out or when the air conditioning or heating system (HVAC) is not working properly. In response, management sends maintenance staff to replace a light bulb or repair/replace faulty HVAC motors. At best, this historic approach has been inadequate and very costly in terms of excess electric power (power) use due to equipment failure when simple maintenance, if caught early, would have corrected the problem and saved money. For example, lighting systems draw excess power because of old or malfunctioning lights, the building users and/or maintenance staff will not usually notice the inefficiency until a light burns out. In the case of HVAC units, compressor motors working inefficiently draw excess power long before an HVAC unit stops working. If caught early, the malfunction could have been repaired before excessive power consumption occurred. Inefficient lights and HVAC units draw significantly more power than do lights and HVAC units operating at peak efficiency—costing the owner of the facility more for electric power.

Another problem with the current method of managing facility equipment is when a building system component needs repairing or replacing, the building manager may not know exactly where the defective light/AC component (unit) is in the facility. The maintenance staff may then have to tear open ceilings and walls to locate the defective piece of equipment. This is very time-consuming and costly. Also, post-pandemic labor shortages have caused a lack of qualified maintenance staff to inspect and repair facility systems.

Know approaches fail to monitor and detect problems in a timely manner. Historically, each separate building system includes HVAC, lighting systems, plumbing systems, central plant cooling and heating systems utilize a piecemeal approach to monitoring each building system separately. Further, early detection of inefficient lights and lighting systems that consume more power than newer systems will allow building managers and owners to lower electric power costs by up to 50 percent due to replacing inefficient units and systems sooner. Moreover, the system sensors would facilitate locating the faulty equipment for replacement or repair in most building systems because the location of the nearby monitoring sensor would be known.

Therefore, what is needed is a system and method for monitoring lighting systems, HVAC systems and other types of building/facility systems using continuous monitoring by sensors coupled with continuous analysis by artificial intelligence (AI) using a machine learning model.

### SUMMARY

In accordance with the various aspects and embodiments of the invention, a system and method are disclosed to control and lower the cost of electricity use and provide a schedule for maintenance for industrial, commercial, medical, military, and residential consumers by utilizing a system that includes, but is not limited to, Lighting System Controllers, electric current transducers, HVAC Central Power Controllers, vibration sensors, and artificial intelligence using machine learning models and software. The system immediately alerts facility system managers of equipment inefficiencies long before the equipment fails. By using an early warning system based on system sensors that detect impending equipment failures, system managers can quickly dispatch maintenance personnel to repair or replace the defective unit. This will save facility owners millions of dollars annually in electric power consumption costs. Repairing or replacing system components before they fail will avoid more costly repairs after component failure.

### BRIEF DESCRIPTION OF THE DRAWINGS

In order to understand the invention more fully, reference is made to the accompanying drawings. The invention is described in accordance with the aspects and embodiments in the following description with reference to the drawings or figures (FIG.), in which, like numbers represent the same or similar elements. Understanding that these drawings are not limitations in the scope of the invention, the presently described aspects and embodiments and the presently understood best mode of the invention are described with additional detail through use of the accompanying drawings.

FIG. 1A shows a system for managing facility climate control and maintenance costs using a fault detection HVAC system controller and a central computer in accordance with various aspects and embodiments of the invention.

FIG. 1B shows a fault detection system for early detection of HVAC equipment failure using specialized sensors and a controller in accordance with various aspects and embodiments of the invention.

FIG. 2 shows a system for managing facility lighting system electricity usage and maintenance via a fault detection system in accordance with various aspects and embodiments of the invention.

FIG. 3 shows a cloud-based fault detection information collection system for monitoring electric energy usage and facility systems maintenance in accordance with various aspects and embodiments of the invention.

FIG. 4. shows a cloud-based Artificial Intelligence (AI) fault detection processing system for building system management and maintenance in accordance with various aspects and embodiments of the invention.

FIG. 5 shows a flow process of a facility energy draw fault detection and reporting system in accordance with various aspects and embodiments of the invention.

FIG. 6 shows a flow process of a facility lighting fault detection system in operation in accordance with various aspects and embodiments of the invention.

FIG. 7 shows a system for producing equipment Malfunction Reports and Billing Invoices for clients in accordance with various aspects and embodiments of the invention.

### DETAILED DESCRIPTION

To the extent that the terms “including”, “includes,” “having”, “has”, “with”, or variants thereof are used in either the detailed description and the claims, such terms are intended to be inclusive in an equivalent manner to the term “comprising”. The invention is described in accordance with the aspects and embodiments in the following description with reference to the figures (Figs), in which, like numbers represent the same or similar elements.

Reference throughout this specification to “one embodiment,” “an embodiment,” or “in accordance with some aspects” and similar language means that a particular feature, structure, or characteristic described in connection with the various aspects and embodiments are included in at least one embodiment of the invention. Thus, appearances of the phrases “in accordance with an aspect,” “in accordance with one embodiment,” “in an embodiment,” “in certain embodiments,” and similar language throughout this specification refer to the various aspects and embodiments of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention.

The ranges of values provided above do not limit the scope of the present invention. It is understood that each intervening value, between the upper and lower limit of that range and any other stated or intervening value in that stated range, is encompassed within the scope of the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

A system, such as a building system fault detection and power management system, offers a wholistic approach to building system management. In accordance with various aspects and embodiments of the invention, the system can monitor a plurality of building systems at the same time from one central computer and can send equipment malfunction and energy usage surge reports to customers in real time. Real time malfunction reports and energy surge reports give building operators and owners an immediate opportunity to repair and correct equipment malfunction at his/her earliest convenience, before excessive building operation costs soar above expected levels.

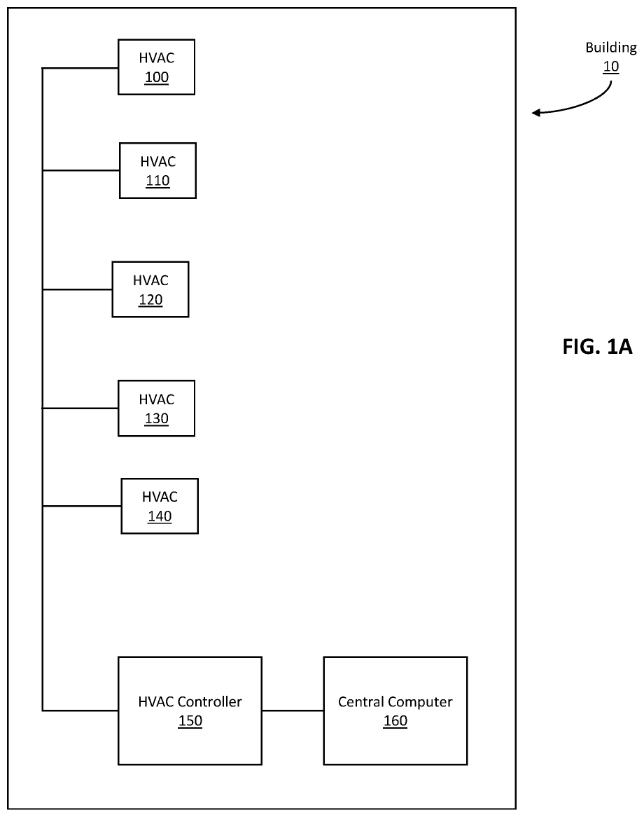

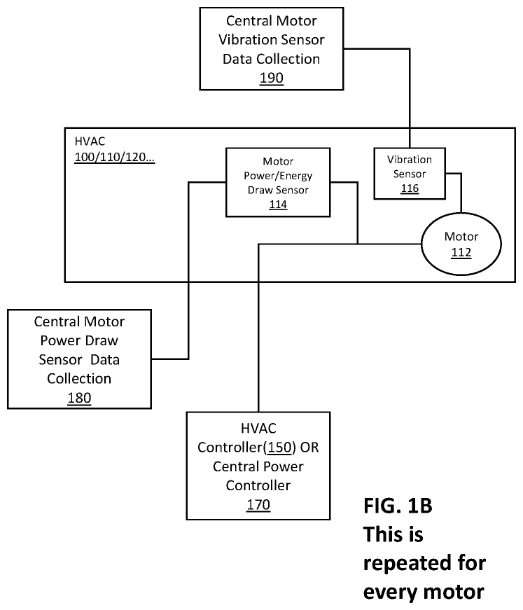

Referring now to FIG. 1A, a system 100 is shown according to various aspects and embodiments of the invention. The system 100 includes HVAC units 101, 110, 120, 130, and 140 within a building 10. The HVAC units are in communication with a HVAC controller 150. The HVAC controller 150 manages energy usage by maintaining building temperature and the timing of when each of the HVAC units are in use. The HVAC controller 150 is also in communication with a central computer 160. In accordance with various aspects and embodiments of the invention, the central computer 160 is shown within the building 10. In accordance with various aspects and embodiments of the invention, the central computer may be remote from the building 10 and the HVAC controller 150 is capable of communication with the central computer 160 through a wireless communication connection or a hardwire communication connection.

Referring now to FIG. 1B, a motor fault detection system 195 for monitoring a HVAC motor's vibrations and a HVAC motor's power draw is shown in accordance with various aspects and embodiments of the invention. The motor fault detection system 195 is repeated for every HVAC motor in the building 10. In accordance with various aspects and embodiments of the invention, each HVAC unit includes a power sensor 114 and a vibration sensor 116.

In accordance with various aspects and embodiments of the invention, the motor fault detection system 195 includes a central motor vibration sensor data collection unit 190 that is in communication with the vibration sensor 116. In accordance with various aspects and embodiments of the invention, the motor fault detection system 195 includes the unit 190 that remotely located and is in communication with the vibration sensor 116 via wireless communication protocol or hardwire communication, such as a physical line.

The vibration sensor 116 is coupled to a motor 112 of a HVAC unit for detection of vibration in/by the motor 112. In accordance with various aspects and embodiments of the invention, the motor 112 is in communication with, and is controlled by, the HVAC controller 150. In accordance with various aspects and embodiments of the invention, the motor 112 is in communication with, and is controlled by, a central power controller 170. In accordance with various aspects and embodiments of the invention, the motor 112 is in communication with, and is controlled by, a central power controller 170 and the HVAC controller 150 working in conjunction with each other and controlled by artificial intelligence (AI) using a machine learning model.

As shown herein, the HVAC controller 150 is co-located with the HVAC unit in accordance with various aspects and embodiments of the invention. As noted herein, the HVAC controller 150 is remotely located with respect to the HVAC unit in accordance with various aspects and embodiments of the invention.

Further, the central power controller 170 is co-located with the HVAC controller 150 in accordance with various aspects and embodiments of the invention. In accordance with various aspects and embodiments of the invention, the central power controller 170 is remote (not shown) relative to/from the HVAC controller 150 and the central power controller 170 uses wireless communication protocol or hardwire communication protocol to connect with the HVAC controller 150 and/or the motor 112.

The motor 112 produces vibrations. When the motor 112 is operating under ideal conditions, then the motor 112 produces vibrations that fall within an optimal or normal vibration range, which is an indication of optimal performance of the motor 112. Each vibration sensor (such as sensor 116) continually monitors the vibrations of its associated motor (such as the motor 112). In accordance with various aspects and embodiments of the invention, the vibration signature (or component performance data) of the motor 112 is communicated to the unit 190. In accordance with various aspects and embodiments of the invention, the vibration sensor 116 continuously monitors (and is capable of time-stamping) the vibration signature of the motor 112. The interval of the time-stamps can be set to any customized and desired value and can range from very frequent or extended time, depending on the condition and age of the motor 112.

In accordance with various aspects and embodiments of the invention, when the vibration range falls outside the optimal or normal operation range, then the system can time-stamp the data to identify the timing of the non-optimal or non-normal event. Thus the vibration signature can be compared to the real-time vibration signature and non-optimal events can be detected, time-stamped.

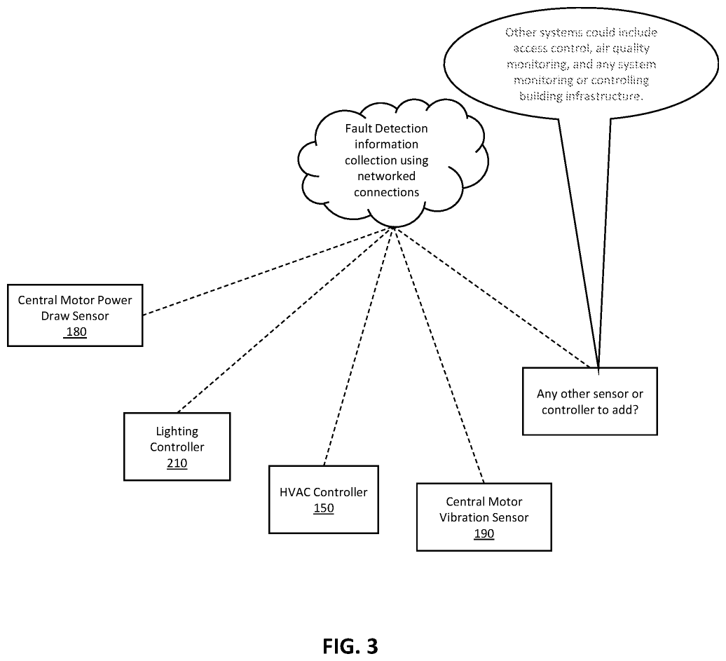

The vibration signature is further communicated, using a network 300, to a unit 302, as shown in FIG. 3, that detects and determines fault by analysis of information collected from the motor 112. In accordance with various aspects and embodiments of the invention, the network 300 is also used to handle the wireless and hardwire communication noted herein.

When the motor 112 begins to malfunction, it will vibrate outside of its optimal vibration range producing an abnormal vibration pattern. The vibration sensor 116 will relay the abnormal vibration pattern to the unit 190, which will then relay the abnormal vibration pattern to the unit 302 for processing and analysis, which may be done using AI and machine learning models.

In accordance with various aspects and embodiments of the invention, the motor 112 is also in communication a motor power/energy draw sensor 114. As noted, the HVAC Controller 150 and/or the central power controller 170 controls the operation of the motor 112. The HVAC controller 150 and/or the central power controller 170 determines when the motor 112 is on or off and at what speed the motor 112 will operate. The sensor 114 monitors how much electric power the motor 112 is consuming at every moment. The electric power draw of the motor 112 is continuously communicated from the sensor 114 to a central motor power draw sensor 180 that collects the information or data. The data includes the electric power draw history of the motor 112, which is then communicated to the unit 302 via network 300. In accordance with various aspects and embodiments of the invention, the motor 112 power draw data is also continuously communicated to the HVAC controller 150 and/or the central power controller 170 for analysis and adjustment.

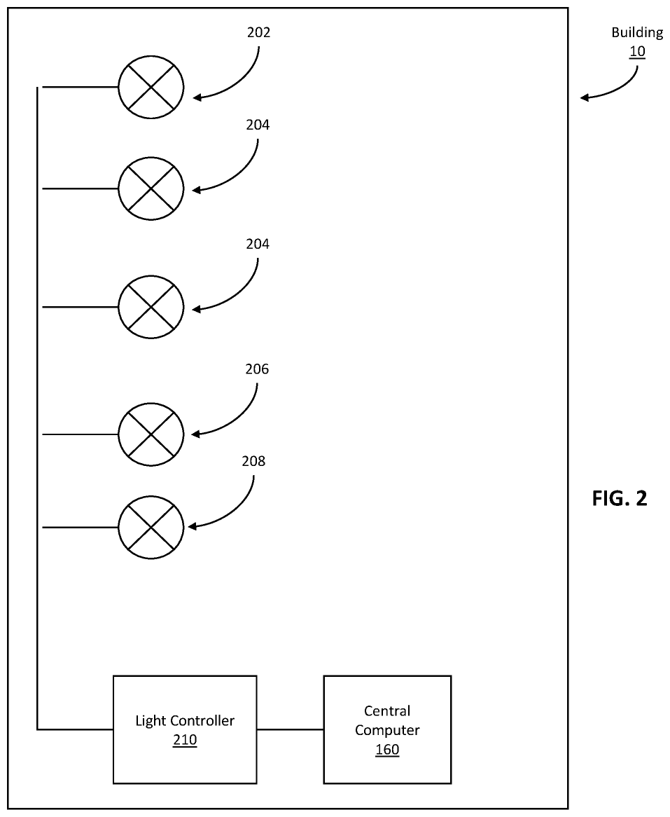

Referring now to FIG. 2 and FIG. 3, a series of lighting units 202, 204, 206, 208, and 210 within building 10 are shown in accordance with various aspects and embodiments of the invention. The lighting units 202, 204, 206, 208, and 210 are in communication with a light controller unit 212. In accordance with various aspects and embodiments of the invention, the lighting units 202, 204, 206, 208, and 210 are connected to the network 300 and using the network 300 to communicate with other components of the system, such as the unit 212. In accordance with various aspects and embodiments of the invention, the unit 212 uses a hardwire connection to communicate with the lights 202, 204, 206, 208, and 210.

In accordance with various aspects and embodiments of the invention, the unit 212 uses a wireless communication protocol and/or the network 300 to communicate with the lights 202, 204, 206, 208, and 210. In accordance with various aspects and embodiments of the invention, the unit 212 (as well as other units that rely on communication) uses both wireless and hardwire communication to ensure redundancy and backup in the event one communication protocol fails or is disrupted. The unit 212 is in communication with the central computer 160.

In accordance with various aspects and embodiments of the invention, the central computer 160 is remotely located (not shown) from the unit 212 and uses a wireless communication channel. In accordance with various aspects and embodiments of the invention, the unit 212 is co-located with the central computer 160 and uses a hardwire communication channel. In accordance with various aspects and embodiments of the invention, the unit 212 uses both wireless and hardwired communication channels regardless of location relative to the central computer 160 and uses a hardwire communication channel.

The unit 212 controls the light. The unit 212 determines when and how the lights in a facility are on at what times. The unit 212 also determines the intensity and/or color of each light. The unit 212 also continuously monitors the power draw (or component performance data) of each light to make sure it is within the desired specification range. When the unit 212 detects that the power consumption of a specific light is outside of the desired specification range, the unit 212 sends the light performance history to the unit 302 via the network 300.

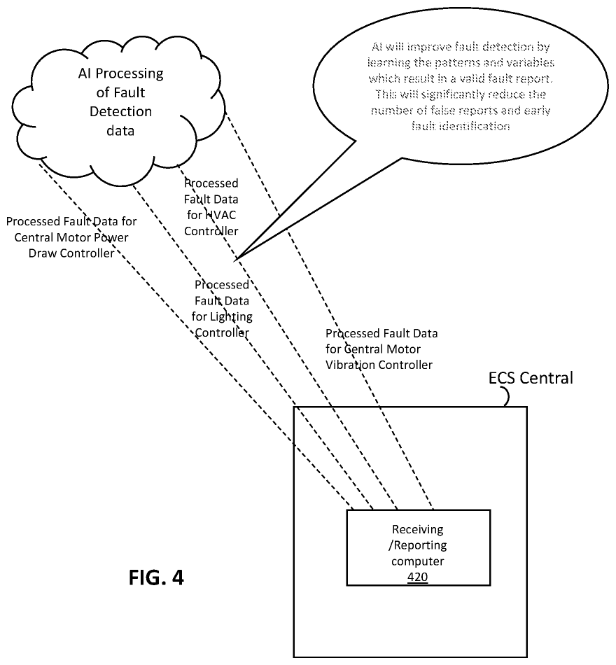

Referring now to FIG. 3, FIG. 4, FIG. 2, FIG. 1A, and FIG. 1B, according to various aspects and embodiments of the invention, the unit 302 receives input via the network 300 from the sensor 180, the unit 212, the HVAC controller 150, the sensor 190, and any other system monitoring or controlling equipment and building infrastructure, such as, but not limited to, building plumbing, access control, fire detection and control, and air quality monitoring.

In accordance with various aspects and embodiments of the invention, when the unit 302 receives a defective motor vibration pattern from the unit 190 via the network 300, the unit 302 instantly processes the information and sends it via network 300 connections to an AI Processing module for fault detection analysis of the data. The same process occurs when the unit 302 receives equipment malfunction data from any other controller or sensor included from any monitored building systems or equipment.

Referring now to FIG. 4 and FIG. 3, according to various aspects and embodiments of the invention, the unit 302 collects information (related to the fault detection and normal operation) from all monitored building systems. In accordance with various aspects and embodiments of the invention, the unit 302 is in communication with a fault processing unit 400, which may be a third-party system that uses AI. AI will improve fault detection by learning the patterns and variables that result in a valid fault report. This will significantly reduce the number of false reports and enhance early fault identification.

In accordance with various aspects and embodiments of the invention, the unit 400 is a cloud-based AI uses a machine learning model that uses feedback to train the AI. The unit 400 is in communication with a computer 420. The unit 400 receives and processes the fault detection data from the unit 302 and analyzes the fault data from each monitored building system or components according to pre-established parameters to determine whether an actionable fault in a system has occurred. If, for example, a system fault, such as a malfunctioning HVAC motor is identified, the fault data for that HVAC motor is sent to the computer 420.

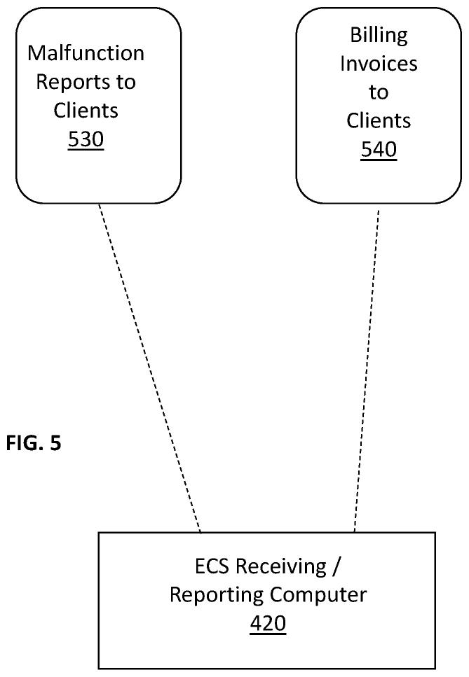

Referring now to FIG. 5 and FIG. 4, according to various aspects and embodiments of the invention, a flow process of a facility fault detection system in operation is shown. The process shown applies to fault detection systems installed for any type of building infrastructure including HVAC systems, lighting systems, plumbing systems, building access systems, communication systems, fire detection and counter measure deployment, and building intranet systems. In this non-limiting example a building's HVAC system is indicated. The following example focuses on a single HVAC motor selected from a plurality of HVAC motors within a monitored building.

Upon instillation or initiation of the system, at step 510, the fault detection system monitors HVAC unit's motor vibration through its sensors. Motor vibration above or below the desired range is considered a defect in the HVAC motor performance. At step 520, the system determines if the HVAC motor vibration intensity indicates a departure in vibration intensity from the desired range based upon historical data or threshold data provided. If a departure from the desired range of motor vibration is found at step 520, then the system sends a Repair/Replacement Needed Report to the customer at step 530 via computer 420. At step 510, the motor vibration fault monitoring system continues to monitor the vibration range for the defective motor. These steps are repeated for every HVAC motor that is being monitored and are performed continuously to provide dynamic and real time data/updates.

If, however, at step 520 the system determines that the monitored HVAC motor is operating within its optimal vibration range, the system will continue to monitor the HVAC motor vibration sensor at step 510.

The fault detection system for building HVAC systems has the potential to save a customer millions of dollars in electric power costs. For example, if the fault detection system finds that the vibration level of an HVAC motor is above the desired range, it will not be operating efficiently and will consume more electricity than an identical motor operating within the historical range. If the HVAC defective motor is replaced and a new motor's vibration profile is within the historical range, it will consume less electricity and save the building owner money each moment it operates.

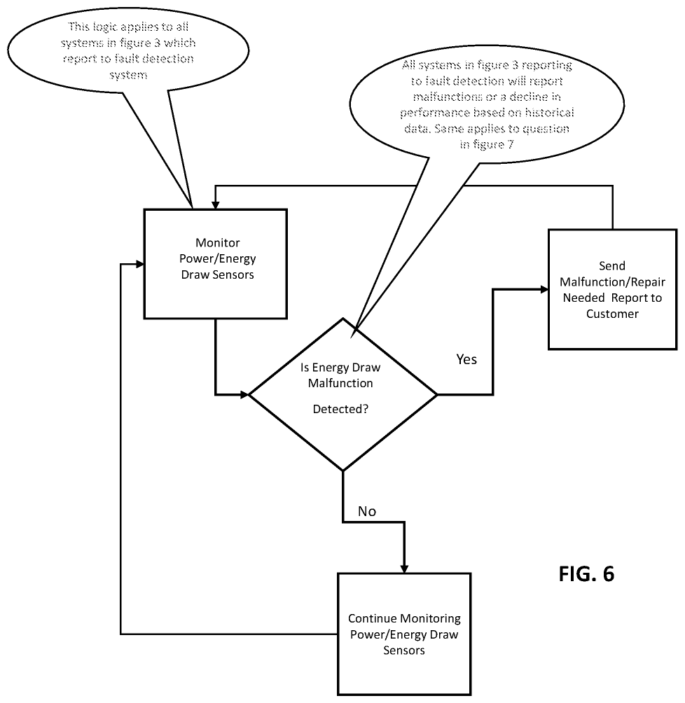

Referring Now to FIG. 6 and FIG. 4, according to various aspects and embodiments of the invention, a flow process of a fault detection system monitoring a building's lighting system is shown. The process shown in FIG. 6 applies to any and all building system components that the system monitors in client's building systems. In this example, the efficiency of individual building lights is being monitored. The system monitors declines in individual light performance. In accordance with various aspects and embodiments of the invention, if a specific light is operating below its optimal range and consuming more electricity than indicated in its desired power consumption range a malfunction/repair report is communicated to the customer and to the central system.

Upon instillation or initiation of the system, at step 610 the system monitors Power Energy Draw/Sensors coupled with each monitored building light. At step 620, the data is analyzed. If at step 620 the monitored light is drawing electric power above its historical range, it is beginning to fail and is costing the customer excess dollars in electric power consumption. If at step 620 a monitored light is found to be not drawing electric power when power is supplied to the light (in other words the light is turned on), it may be burned out. In both of these instances at step 630 a Malfunction/Repair Report is sent to the customer via the computer 420. The building manager or owner can then address the problem and, for example, the defective light is replaced. At step 610 the fault monitoring system continues to Monitor Power/Energy Draw Sensors for the defective light.

If, however, at step 620 the fault detection system finds that a particular light is operating within its desired power consumption range, the system will continue to monitor power/energy draw sensors at step 610 and Malfunction/Repair reports will not be sent out.

The power management fault detection for electric lighting systems is capable of saving a customer with the system installed in one of its buildings millions of dollars in electricity cost over time. Defective or dying lighting units with their increasing electricity consumption will be detected early and replaced. New lighting units will operate within the desired range of electric power consumption, well below that of a defective or dying unit, therefore saving the customer the difference in power consumption between the defective unit and the new replacement unit.

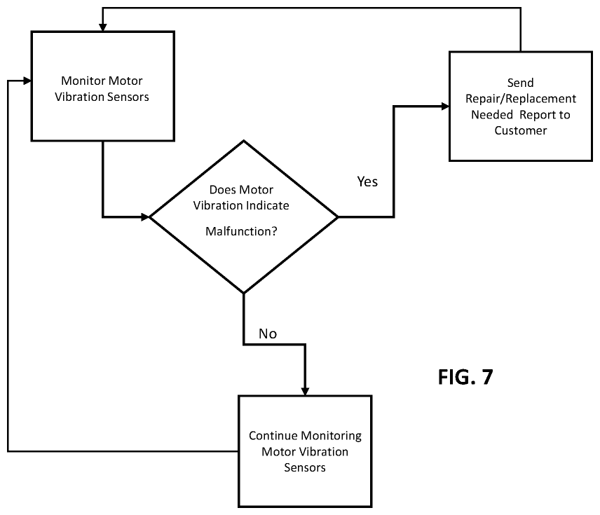

Referring now to FIG. 7, FIG. 4, and FIG. 1B, according to various aspects and embodiments of the invention, shows a Receiving and Reporting Computer 420 generating a Malfunction Report 730 that is sent to a client of a monitored building. The Malfunction Reports 730 will tell the clients what type of malfunction has occurred and where within the building it has occurred. In accordance with various aspects and embodiments of the invention, the Malfunction Report 730 includes information about the cost of ignoring the repair identified in the report (i.e. not repairing or replacing). For example, the report would identify the location of a defective HVAC Motor 112 because all the individual HVAC motors have identification data associated with the information collected by the sensors that uniquely identifies the motor. In accordance with various aspects and embodiments of the invention, the Malfunction Report 730 includes details about ordering the repairs through the provider of the report and what the provider charges for repairing and/or replacing the defective HVAC Motor 112.

In accordance with various aspects and embodiments of the invention, the computer 420 also sends Billing Invoices 740 to Clients. The Billing Invoices 740 detail the prices and charges for the services including, but not limited to: (1) installing building system fault detection systems; (2) monitoring customer building systems for defective operating units; (3) monitoring building systems for excess power consumption; (4) maintenance contracts; (5) monitoring central climate control plants for excess water consumption; (6) and system data sold to AI trainers for cloud service providers; and (7) repair of installed monitoring equipment. The client can approve invoices, pay invoices, or respond to the computer 420 using any form of communication, including a link, a Quick Response (QR) code, or approval text communication back to the computer 420.

Some of the systems discussed herein work by executing code on computer processors. A computer or computing device or computer processor includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, ‘processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host. Various embodiments store software for such processors as compiled machine code or interpreted code on non-transitory computer readable media.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

In accordance with the teaching of the invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

Unless defined otherwise, all technical and scientific terms used herein have the same meaning as commonly understood by one of ordinary skill in the art to which this invention belongs. The verb couple, its gerundial forms, and other variants, should be understood to refer to either direct connections or operative manners of interaction between elements of the invention through one or more intermediating elements, whether or not any such intermediating element is recited. Any methods and materials similar or equivalent to those described herein can also be used in the practice of the invention. Representative illustrative methods and materials are also described.

An article of manufacture or a system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates, which may need to be independently confirmed.

Therefore, the scope of the invention is not intended to be limited to the various aspects and embodiments discussed and described herein. Rather, the scope and spirit of invention is embodied by the appended claims.

What is claimed is:

1. A system for detecting malfunctioning building system components, the system comprising:
a sensor that monitors a building system component, wherein the building system component operates within a performance range under optimal conditions;
a controller in communication with the sensor, wherein the controller receives component performance data from the sensor, wherein the controller generates a time-stamp for the component performance data to produce time stamped performance data; and
an artificial intelligence (AI) using a machine learning model, the AI is in communication with the controller, wherein the AI receives at least one of the component performance data and the time stamped performance data from the controller and wherein the AI uses at least one of the component performance data and the time stamped performance data to:
generates a repair report;
send the repair report to a remote location; and
use at least one of the component performance data and the time stamped performance data to further train the machine learning model.

2. The system of claim 1 wherein the AI analyzes the component performance data to make a decision regarding at least one of repair and replace of the building system component that is includes in the repair report.

3. The system of claim 1, wherein the time-stamp is a non-optimal time-stamp and represents when the component performance data falls outside of the performance range under optimal conditions.

4. The system of claim 1, wherein the building system component is a HVAC.

5. The system of claim 4, wherein the component performance data is a measure of vibration.

6. The system of claim 4, wherein the component performance data is a measure of power consumption.

7. The system of claim 1, wherein the building system component is a light unit.

8. The system of claim 7, wherein the component performance data is a measure of power consumption.

9. A non-transitory computer readable medium for storing code that is executed by a processor to cause a system to:
receive performance data from a sensor associated with a building system component;
analyze the performance data in order to monitor variations in performance levels of the building system component;
determine if a variation in the performance data is outside of an optimal range;
use a machine learning model to analyze the building system component to determine if the building system component is a defective component;
determine an exact location for the defective component; and
generate a report indicating that the defective component must be at least one of repaired and replaced to maintain optimal performance.

10. The non-transitory computer readable medium of claim 9, wherein the system is further caused to train the machine learning model using the performance data.
